(19) United States
(12) Patent Application Publication
(10) Pub. No.: US 2024/0180356 A1
(43) Pub. Date: Jun. 6, 2024

(54) MILK FOAMING DEVICE WITH THE APPLICATION OF PRESSURIZED GAS AND METHOD FOR THE PRODUCTION OF MILK FOAM

(71) Applicant: EVERSYS S.A., sierre (CH)

(72) Inventors: Sebastien Robyr, Sierre (CH); Gregoire Locher, Daillon (CH)

(21) Appl. No.: 18/285,799

(22) PCT Filed: Oct. 12, 2022
(86) PCT No.: PCT/EP2022/078365

§ 371 Date: Oct. 5, 2023

(30) Foreign Application Priority Data
Oct. 29, 2021 (DE) 102021128339.6

(51) Int. Cl. A47J 31/44; A47J 31/46

(52) U.S. Cl. CPC A47J 31/4485; A47J 31/468

(57) ABSTRACT

The invention relates to a milk frothing device 1, a beverage preparation device 100 comprising the milk foaming device 1, and a method for producing milk foam. Particularly in the coffee beverage industry, there is a need for producing a variety of different milk modifications, such as fine-pored or coarse-pored milk foam, based on different milk starting products. This often requires a variety of different equipment.

The invention makes it possible to produce a wide range of different milk modifications by applying compressed air to milk on an outlet side A of a pumping device 2.

The invention relates to a milk frothing device according to the preamble of claim 1, a beverage preparation device and a method for producing foamed milk (milk foam). Milk is understood to mean, in addition to animal milk products, i.e. glandular secretions of female animals of the class Mammalia, also plant-based milk products as well as comparable products, e.g. soy milk or almond milk.

For the production of hot and cold milk or milk-mix drinks such as cappuccino or latte macchiato, milk is processed not only in liquid form but also in foamed form. The milk is usually foamed by mechanical agitation of the milk in agitators, by adding steam to the milk and/or by adding air to a stream of milk flowing through a venturi nozzle. For the production of a wide range of milk and milk-mix drinks, it is necessary to provide different milk modifications, e.g. milk in cold or hot form as well as in foamed or non-foamed form, whereby it may be desirable to be able to control and selectively adjust foam properties (water content, foam bubble size, density, etc.) as well as the temperature of the milk modification in order to influence the aesthetic and glossa-tactile as well as the taste sensation.

The milk foam can be part of a mixed milk drink, as in a latte macchiato, for example, or it can form a foam crown on the drink, as in a cappuccino. A distinction can be made, for example, between a firm, dense and coarse-pored foam and a fine-pored milk foam. The coarse-pored milk foam is single-phase when it is produced, and after a certain standing time in a cup it changes into a two-phase milk foam consisting of a lower liquid layer of hot milk and the layer of firm milk foam on top of it. This coarse-pored milk foam can be used, for example, to make latte macchiato. However, this coarse-pored firm foam is not suitable for creating decorations in the milk foam (latte art) on a cappuccino. A more liquid, creamy and fine-pored milk foam can be used for this, which consists of micro-fine air bubbles and is also known as microfoam. This microfoam is preferably single-phase with a silky shiny surface and contains very small air bubbles evenly distributed in the foam, which can hardly be seen with the naked eye. When this micro-foam is poured onto the surface of an (espresso) coffee containing a crema, a partial mixing of the crema and the milk foam takes place, resulting in a discolouration of the white milk foam with the dark crema of the coffee. This makes it possible to draw pictures on the foam surface (latte art).

It is known to influence foam properties during foam production in devices for foaming foamable liquids, such as milk. It is also known to subsequently change the consistency of produced foam. The modification of the foam properties can be achieved, for example, in an automatic coffee machine by means of a post-processing device as described in EP 2 798 988 B1. Here, milk is passed under a preselected pressure through a labyrinth of channels surrounded by baffles in order to standardise the air bubbles of the foam and thus to equalise the consistency of the foam. By adjusting pressure ratios in the post-processing device, it is also possible to change the consistency of the milk foam from fine, i.e. with very small air bubbles, to coarse, i.e. with large air bubbles, and from loose to creamy to firm.

Specific foam properties with the known post-processing device can therefore only be achieved—without a change to the post-processing device—by adjusting pressure ratios (i.e. through higher pressures of a steam supply line), which can be disadvantageous in terms of water dilution and/or overheating of the foam (coagulation of milk protein).

Furthermore, more and more different milk-based products such as low-fat milk, lactose-free milk, as well as vegetable milk substitutes such as soy and almond milk are being offered. These milk starting materials for the production of milk foam have different processing properties (fat content, foamability, heatability, viscosity, etc.), so that it may be necessary to adapt the production parameters for the preparation of milk foam to the milk starting material in order to produce milk foam with consistent or comparable properties.

EP 3 763 258 A1 shows the mixing of an air-milk mixture after enriching the milk with air via a Venturi nozzle in a swirl chamber. The foamed milk can then be tempered via a flow heater. The disadvantage is that the foam properties can only be controlled to a limited extent. In particular, it is not possible with the device shown in EP 3 763 258 A1 to produce different types of foam, such as fine-pored and coarse-pored foam.

EP 2 156 771 A1 teaches to combine a gas flow, in particular an air flow, and a milk flow for frothing milk and to introduce them together on an inlet side into a pump, in particular a gear pump, whereby the gas-milk mixture is foamed into a milk foam as it passes through the gear pump. The milk foam can then be heated on the outlet side of the pump by applying steam. With this known milk frothing device, both cold and warm milk froth can be produced, whereby cleaning the device with steam is easily possible. However, the introduction of the mixture of milk and gas on the inlet side of the pump can lead to disturbances of the pump operation and in particular to a slipping of a gear pump preferably used as a pump and to a jerky output of the milk foam on the outlet side of the pump. Pump wear is also high due to cavitation.

Against this background, the invention pursues the objective of providing a milk frothing device, a beverage preparation device with such a milk frothing device and a method for producing milk foam, with which milk foams with adjustable properties can be produced and dispensed with a constant volumetric flow rate without malfunctions and in rapid succession. Preferably, it should also be possible to produce different types of milk modifications, such as cold or warm milk as well as cold or warm milk foam, with production parameters adapted to different milk starting products (cow's milk, lactose-free milk, almond milk, hemp milk, soy milk, kangaroo milk, etc.) with freely adjustable volumetric flow rates. At the same time, a high level of functional integration with a small size and few parts, a long service life and low maintenance requirements are to be realised.

These tasks are solved by a milk frothing device with the features of claim 1, by a beverage preparation device with the features according to claim 16, and by a method with the features of claim 21.

The milk frothing device according to the invention comprises a pumping device with an inlet side and an outlet side for conveying milk from the inlet side to the outlet side. A milk supply line can be connected to the inlet side so that, in particular, cooled milk from a storage container can be introduced into the pumping device and delivered via the outlet side. The outlet side can be connected to a milk dispensing line for dispensing the milk foam. The milk frothing device is characterised in that a gas inlet for introducing a pressurised gas for foaming the milk is arranged on the outlet side of the pumping device. Pressurised gases that are compatible with foodstuffs, such as air, nitrogen, oxygen, carbon dioxide or mixtures thereof, for example nitrous oxide (N₂O), are used as the pressurised gas.

The term “pressurised gas” shall not include hot water steam, which is usually provided by a water steam generator, e.g. a boiler. The term “pressurised gas” shall also not include wet water steam, i.e. gas with a water content above the saturation limit of the gas with respect to water.

In the context of the invention, pressurised gas means in particular an essentially water-free pressurised gas, i.e. a pressurised gas or gas mixture under pressure whose water content has not been intentionally increased. An example of an essentially water-free pressurised gas within the meaning of the invention is compressed ambient air which contains a proportion of water in the form of natural humidity.

The milk is mixed with the pressurised gas on the outlet side on the high-pressure side of the pumping device. By applying the pressurised gas to the milk on the outlet side, the function of the pumping device is not negatively influenced by the pressurised gas and, in particular, slipping or free spinning of the pumping device is prevented and a uniform delivery of milk foam on the outlet side is made possible. Furthermore, the delivery speed of the milk and thus the delivery rate of the pumping device can be adjusted independently of the foam properties. By supplying the pressurised gas at different feed pressures and thus in different quantities at different delivery speeds, both fine-pored and coarse-pored milk foam can be produced. Without introduction of pressurised gas, the milk frothing device can also be used as a feed pump for the milk without producing milk foam. Other and in particular separate delivery means or the use of different milk frothing devices to produce different milk foams are therefore unnecessary.

Inlet side and outlet side are to be understood as essentially synonymous with low pressure side and high pressure side of the pumping device. “On the outlet side” is therefore to be understood as “assigned to the high pressure side”. The gas inlet for introducing the pressurised gas can be arranged on the outlet side inside or outside a housing of the pumping device.

Further features and advantageous embodiments of the invention are apparent from the subclaims and the following description.

The milk frothing device preferably has no gas inlet on the inlet side of the pumping device for the introduction of the or a pressurised gas for foaming the milk. Embodiments that foam milk via the introduction of a pressurised gas on the inlet side of the pumping device are not covered by this embodiment of the invention.

In an advantageous embodiment, the pumping device of the milk frothing device comprises at least one housing in which mechanically moved conveying means are arranged in a conveying chamber. At least one first and one second access opening and at least one first outlet opening are provided in the housing. The first access opening is arranged on the inlet side upstream, i.e. in the flow direction of the milk before the conveying means, and forms an inlet for milk into the housing of the pumping device. The outlet opening is arranged downstream on the outlet side, i.e. behind the delivery means in the flow direction of the milk, and forms an outlet from the delivery chamber for dispensing the milk foam. A second access opening is arranged on the outlet side and preferably in the area of the conveying means. The pressurised gas is introduced into the conveying chamber via the second access opening for foaming the milk. The second access opening forms the gas inlet.

As the pressurised gas is preferably fed in on the outlet side within the housing, in particular within the conveying chamber of the pumping device, not only foam-forming mixing effects due to the pressurised gas feed but also turbulence effects generated by the delivery means can be used advantageously for foaming the milk. The feed pressure of the pressurised gas can thus be kept comparatively low, as the kinetic energy for frothing the milk does not have to be solely pressure-related.

The pumping device is preferably a pumping device with mechanical conveying means. Continuous (e.g. gear pumps) or cyclically operating (e.g. piston pumps, diaphragm pumps) positive displacement pumps can be used as pumping devices.

Preferably, the pumping device is designed as a gear pump, especially as an external gear pump or as an internal gear pump. A gear pump comprises two gear wheels that mesh with each other and are arranged to rotate about two parallel axes of rotation, the teeth of which provide delimited delivery volumes when engaged. Gear pumps have low moments of inertia and high control dynamics. Due to their fast response behaviour, even small delivery volumes of milk (shots) can be achieved at high delivery pressures. This means that a desired pressure difference on the outlet side of the delivery chamber can be produced almost instantaneously, i.e. without a pressure build-up phase. This reduces wastage quantities with insufficient quality. Other pump types such as gear ring pumps, diaphragm pumps or piston pumps can also be used.

An expedient arrangement of the second access opening in the area of the pumping means of the pumping device comprises both an arrangement in which the second access opening has no mechanical contact with the pumping means of the pumping device—for example by arrangement radially outside a tip diameter of a conveying means designed as a gear wheel—or an arrangement in which the second access opening has a mechanical contact with the conveying means of the pumping device, namely in such a way that the access opening is cyclically covered and uncovered by moving conveying elements of the pumping device, for example by the access opening being arranged radially between a root diameter and a tip diameter of a conveying means in the form of a gear wheel of a gear pump. By cyclically releasing the access opening, a pulsating pressurisation of gas is possible. Thereby the pumping means of the pumping device and the second access opening form a stutter valve without additional components.

It can be useful if the outlet opening comprises or is designed as a nozzle and/or a throttle valve. This allows the pressure in the delivery chamber on the outlet side to be adjusted in a controlled manner.

It is also advantageous if the second access opening comprises or is designed as a nozzle and/or a throttle valve. Due to a suitably selected nozzle shape, hydrostatic pressure components of the pressure of the pressurised gas applied to the access opening can be advantageously converted into dynamic pressure components when passing through the nozzle, for example. This allows the pressurised gas to be introduced into the milk at high differential velocities, thus achieving excellent mixing. The nozzle or the throttle valve can be integrally formed as an opening in a housing of the pumping device. Advantageously, however, they are separate parts inserted into the housing and replaceable, e.g. a bushing insert. By using replaceable bushing inserts, the milk frothing device can also be subsequently adapted to changed production parameters.

In order to achieve the best possible homogenisation of the milk foam, in particular with a uniform bubble size of bubbles with homogeneous distribution in the milk foam, the second access opening (gas inlet) is preferably arranged in the immediate vicinity of the meshing of the gearwheels on the outlet side of a gear pump. By placing it as close as possible to the gearwheel, the pressurised gas can be displaced by decreasing delivery volumes of the gearwheels and thus accelerated in the flow direction of the milk, i.e. in the direction of the outlet opening.

The pressurised gas is preferably introduced into the milk flow perpendicularly or tangentially to the direction of flow of the milk. It is also possible to introduce the pressurised gas against the direction of flow or in mixed forms, e.g. at an angle. An introduction against the flow direction of the milk is advantageous if a high turbulence and a good mixing between the pressurised gas fed in via the second access opening and the milk is desired to produce a high foam quality.

In an advantageous embodiment, the pumping device may comprise more than two access openings and in particular several gas inlets. The access openings forming the gas inlets can advantageously be arranged opposite each other and facing each other in the housing of the pumping device. Alternatively or additionally, it is also possible to arrange several access openings next to or above each other. By using several gas inlets, it is possible to increase the foaming rates and thus the milk foam throughput while keeping the size of the pumping device approximately the same.

The first access opening and the outlet opening can be arranged parallel and in particular coaxially. However, it is advantageous if the outlet opening is arranged parallel and offset to the access opening. This creates baffle effects that positively influence the mixing and thus the foaming of the milk.

The housing of the pumping device expediently comprises a preferably planar Bottom side, a preferably planar Top side running parallel at a distance therefrom, and at least one side wall arranged preferably perpendicular thereto. The side wall can be circumferential, in particular cylindrical. However, the housing can also be designed as a polygon with several side walls, in particular cuboid-shaped with four side walls perpendicular to each other. The side walls delimit the conveying chamber. The first access opening and the outlet opening are expediently formed centrally in the circumferential side wall at respective opposite points or are arranged in two opposite side walls. The second access opening is preferably arranged in the Top side and/or Bottom side of the housing. The conveying means are preferably rotatably mounted about axes of rotation extending between the Top and the Bottom sides.

The access openings and/or the outlet opening advantageously each merge into a fluid channel located in the housing, whereby each fluid channel can form a different cross-section compared to an opening cross-section of the access opening or outlet opening. A milk supply line can be connected to a first fluid channel, a milk dispensing line can be connected to a third fluid channel and a pressurised gas line can be connected to a second fluid channel. The lines are expediently designed as hose connections with corresponding quick coupling elements for connection to the fluid channels.

It is expedient that a non-return valve is arranged at least in the second fluid channel. This non-return valve can prevent milk from flowing back into the pressurised gas line. Non-return valves can also be arranged in the first and third fluid channels. This has the advantage of a high level of functional integration, so that, among other things, shorter connection or hose paths are possible for e.g. the milk supply line and the milk dispensing line.

In an advantageous embodiment, the second fluid channel has a further opening with an adjoining further channel to form a branch. Water or a cleaning fluid for cleaning purposes can be fed into the housing via the additional channel. This can be used, for example, to clean the conveying chamber on the outlet side or the fluid lines connected to it.

The second opening access can have an opening diameter of max. 10 mm, preferably max. 5 mm, or particularly preferably max. 0.05 mm. Large orifice diameters allow high mass flow rates, but require correspondingly powerful pressurised gas sources. Small diameters allow high pressure differences when feeding the pressurised gas into the delivery chamber and allow excellent foaming.

If several access openings are used to form more than two gas inlets, these can also be designed with different diameters. The access openings can be fluidically connected in parallel and can be supplied with pressurised gas either together or separately via an electronic control valve. The separate control of different access openings with different opening diameters makes it possible to produce a wider range of different milk foams, in particular milk foams with particularly large and particularly small pore sizes, with the same milk foaming device.

Furthermore, it is advantageous if the first opening access has a first opening diameter and the outlet opening has a third opening diameter, whereby the third opening diameter is smaller than the first opening diameter. This makes it particularly easy to increase the back pressure on the outlet side of the delivery chamber. This has a beneficial effect on foam formation.

In order to provide pressurised gas via the gas inlet of the pressurised gas, in an advantageous embodiment, the pressurised gas inlet can be connected or is connected to a compressor for generating pressurised gas under pressure. Compressor means a compressor machine which compresses a gas by mechanical work. Instead of a compressor, another source of pressurised gas, in particular a pressurised gas cylinder, such as a pressure bottle, can also be used. The use of a compressed gas cylinder can simplify the supply of pressurised gas, but in return requires regular replacement of the compressed gas cylinder.

In one embodiment, the pressurised gas can be supplied under an approximately constant and absolute feed pressure, preferably a feed pressure of at least 3 bar, in particular in the range of 4 bar to 10 bar, and especially preferably of at least 6 bar. A feed pressure that remains constant over time is technically particularly easy to realise. However, especially in the case of low milk flow, 1 bar or less may also be sufficient, e.g. to produce microfoam.

In an advantageous embodiment, the pressurised gas is provided under a supply pressure (feed pressure) which is e.g. more than 0%, preferably more than 15%, 30% or 50% higher than the pressure on the outlet side of the milk frothing device when no pressurised gas is supplied. In particular, a relative feed pressure of at least 30% above the dynamic pressure of the milk flow on the outlet side ensures a homogeneous distribution of the pressurised gas flow in the milk flow and has the further advantage that the foam pattern of the milk foam can be changed depending on the pressure difference present. If the pumping device operates with variable delivery speeds, this also requires an additional control effort of the pressurised gas source.

In order to be able to specifically regulate the supplied pressurised gas quantity and/or the dynamic pressure of the supplied pressurised gas, it is advantageous if the milk frothing device comprises a pressure regulating device (control device).

In one embodiment, the pressure regulating device may comprise an e.g. electromagnetically controllable proportional valve arranged between the compressor and the gas inlet. This enables simple activation and precise control of the feed pressure of the pressurised gas.

Alternatively or additionally, the pressure regulating device can also comprise a shut-off valve (also: stutter valve) that opens and closes at a high cycle rate, whereby the shut-off valve is arranged between the compressor and the gas inlet. The shut-off valve is opened and closed with a high number of cycles according to the principle of pulse width modulation, so that a medium feed pressure of the pressurised gas can be achieved. In addition, this enables a very fine adjustment of the amount of pressurised air provided in the pumping device.

The pressure regulating device may alternatively or additionally comprise a discharge valve for discharging pressurised gas provided by the compressor. The discharge valve is arranged in the pressurised gas line. This can increase the bandwidth of the air volume provided compared to a control device with a fast-switching shut-off valve.

It is also possible to connect the pressure regulating device directly to the compressor in such a way that the compressor itself has a short response and is designed to be controllable so that the compressor is activated, deactivated and/or adjusted in its output as required. In this case, the compressor is essentially directly connected to the gas inlet.

A combination of the listed variants of the pressure regulating device is possible.

The compressor may further be designed with or comprise a buffer tank to form a gas pressure reservoir. Via the buffer tank, pressurised air can be fed into the pumping device even without simultaneous operation of the compressor. Due to such a temporal decoupling of pressurised gas generation and use of pressurised gas, compressors with low output of pressurised gas but higher efficiencies can be used. In addition, noise emissions during milk foam production can be avoided.

The invention further relates to a beverage preparation device, in particular for coffee and coffee-mixed beverages, which includes a milk foaming device as described above.

The beverage preparation device comprises a dispensing device for dispensing milk in a foamed and/or non-foamed and/or heated and/or non-heated state, wherein the dispensing device for dispensing milk is preferably connected to the outlet side of the milk frothing device only and exclusively via a milk dispensing line.

The milk frothing device can thus provide different types of milk for all beverages of the beverage preparation device. The use of different milk frothing devices for the production of different milk modifications, such as liquid and cold milk, liquid and hot milk, cold milk foam or warm milk foam in different textures (coarse-pored, fine-pored, . . . ), is therefore no longer necessary.

To provide heated milk or heated milk foam, a heating device is expediently arranged in the milk dispensing line. The heating device is preferably designed as a continuous flow heater, in particular an electric continuous flow heater, preferably a thin film heater. This allows the milk to be heated without mixing with heat transfer fluids, such as hot steam. Adverse changes in the foam quality due to mixing with heat transfer fluids such as steam for heating, which for example cause water dilution of the milk foam, can thus be avoided.

The heating device can also be designed as a steam injector for feeding hot steam, in particular water steam, into the milk dispensing line, whereby the steam injector is coupled to a steam source or comprises a steam source. A combination of milk heating by continuous heating and steam input is also conceivable.

The invention also relates to a method for producing foamed milk. In the method, milk located in a housing of a pumping device is subjected to a pressurised gas, in particular pressurised air, in the region of moving conveying means, such as teeth of a gear pump for conveying the milk, from a low-pressure side of the pumping device to a high-pressure side of the pumping device, by introducing the pressurised gas into the milk on the high-pressure side.

The pressurised gas can be an at least substantially water-free and pressurised gas or gas mixture with a temperature of less than 100° C., preferably less than 80° C., and in particular less than 40° C. If the pressurised gas is at a low temperature, e.g. less than 30° C., the cold milk supplied and foamed with the pressurised gas is at least not substantially heated, so that cold milk foam can also be produced. However, if the milk is to be heated, hot pressurised gas can also be used specifically to heat the milk, although this involves a great deal of technical effort due to the low heat capacity of essentially water-free gases.

The pressurised gas can be pressurised air, which is generated by means of a compressor from sucked-in ambient air. However, nitrogen or carbon dioxide from a pressure vessel, for example, can also be used as the pressurised gas.

The pressurised gas has a pressure that is considerably higher than the ambient pressure.

In an advantageous variant of the process, the pressurised gas can be applied to the milk in a pulsating manner. Due to the pulsation, turbulence effects during the introduction into the pumping device and thus the foam formation rate can be increased. This allows higher flow rates of the milk with a constant foam quality, and thus a higher volume flow of the milk foam produced. A continuous, i.e. non-pulsating, introduction of the pressurised gas is possible.

Pulsation can be achieved, for example, by means of a stutter valve. However, it can also be achieved by dynamically controlling a compressor that supplies the pressurised gas. A combination of stutter valve and regulated control of a compressor is possible.

A stutter valve is a fast-switching valve (shutter valve) with which a medium pressure can be achieved by superimposing high pressure pulses with low pressure pulses. The shutter valve is e.g. electromagnetically controlled. Dynamic control of the compressor means in particular a variable-speed control of the compressor that provides a desired pressure in near real time.

However, the pressurised gas can also be supplied via an access opening arranged in such a way that the access opening is cyclically covered and uncovered again by moving conveying elements of the pumping device, for example by arranging the access opening radially between a root diameter and a tip diameter of a gearwheel of a gear pump.

Pressure sensors can usefully be provided in the pressurised gas supply line, in the second fluid channel or in an outlet-side area of the conveying chamber.

The invention is described below by way of example with reference to the embodiments shown in the accompanying figures. Thereby show:

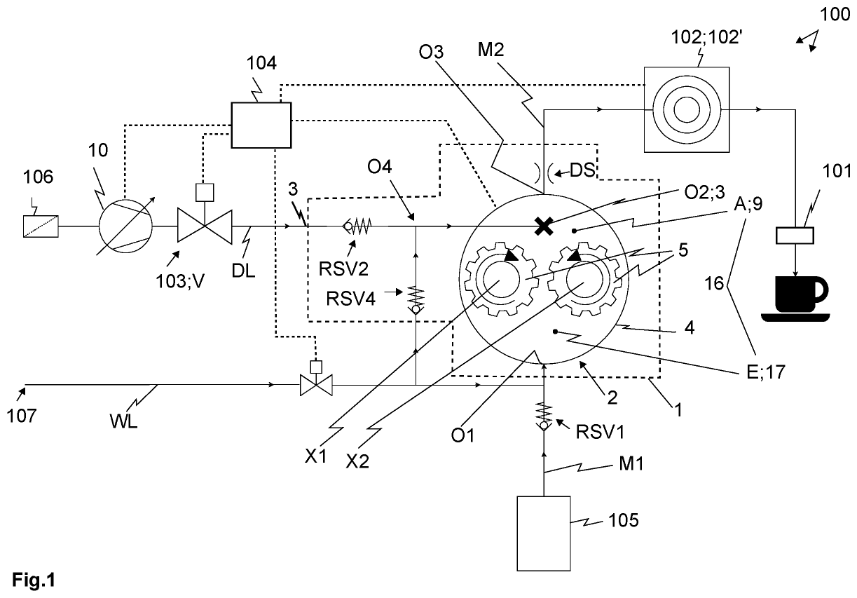

FIG. 1 a schematic representation of a beverage preparation device according to the invention with a milk foaming device according to the invention,

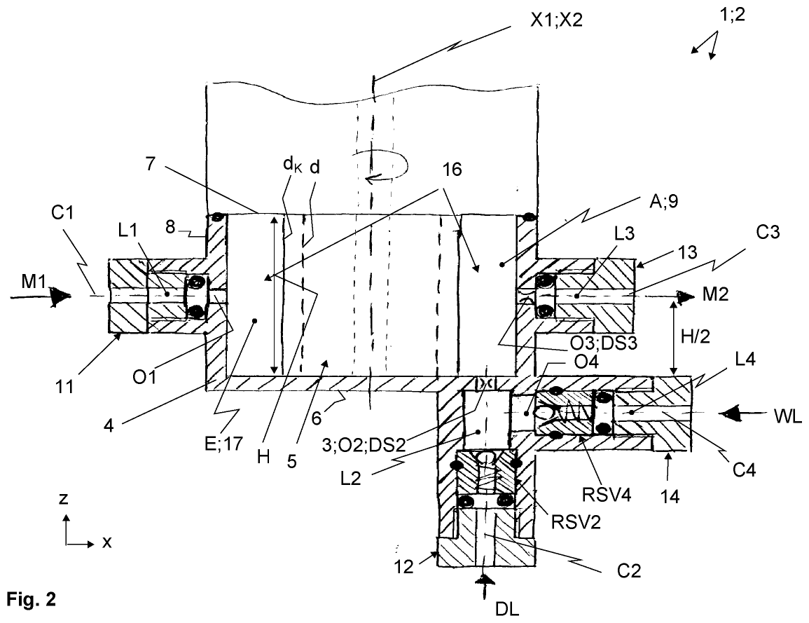

FIG. 2 a cross-sectional view of a milk frothing device according to the invention,

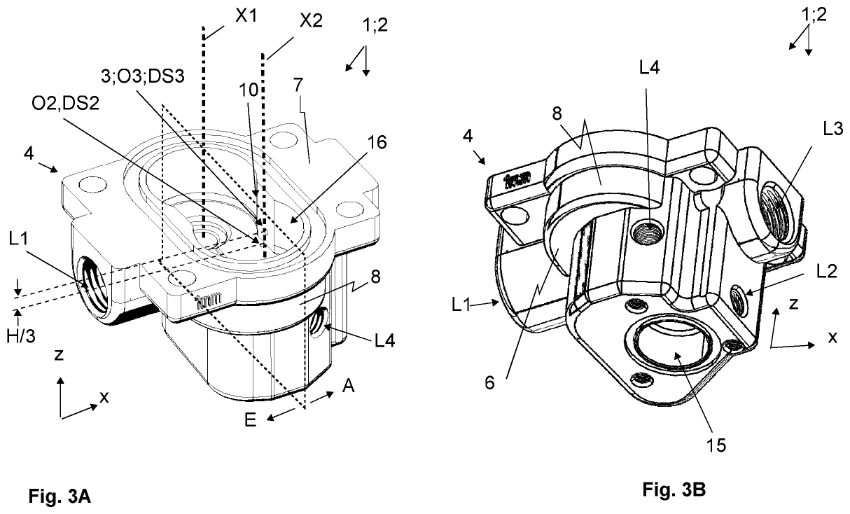

FIG. 3A a first perspective view of a milk frothing device according to the invention,

FIG. 3B the milk frothing device according to the invention from FIG. 3A in another perspective, and

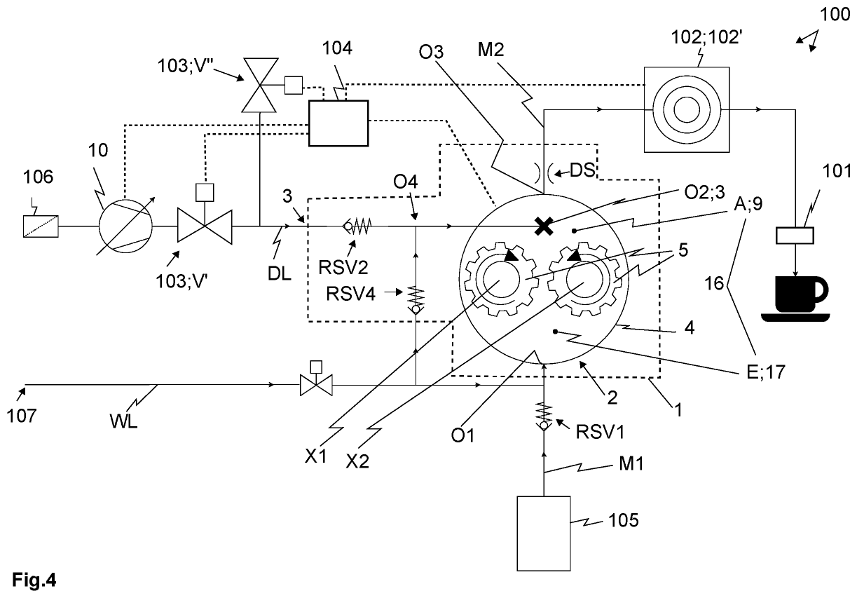

FIG. 4 a schematic representation of a beverage preparation device according to the invention with a milk foaming device according to the invention analogous to FIG. 1 with a modified pressure regulating device.

FIG. 1 schematically shows a beverage preparation device 100 for preparing cold and hot beverages based on coffee and milk with a milk system.

The milk system of the beverage preparation device 100 has a milk container 105, a milk frothing device 1 comprising a pumping device 2 with an inlet side E and an outlet side A, and a dispensing device 101. The pumping device 2 is connected to the milk container 105 on the inlet side E via a milk supply line M1 and to the dispensing device 101 on the outlet side A via a milk dispensing line M2. On the outlet side A, the pump device 2 is also connected via a pressurised gas line DL to a compressor 10, which draws in and compresses ambient air via a filter element referred to here as air source 106. The compressed air (pressurised air) is fed into the pumping device 2 via the pressurised gas line DL and a gas inlet 3. A proportional valve V, which can be controlled electromagnetically by a control unit 104, is also arranged between the compressor 10 and the pumping device 2. The milk supply line M1 is connected via a branch to a water connection 107 via a water line WL. For tempering and heating milk or milk foam, a heating device 102 in the form of a continuous flow heater 102′ is also arranged in the milk dispensing line M2.

In the milk supply line M1, the pressurised gas line DL and the water line WL there are backflow obstacles in the form of check valves RSV1, RSV2 and RSV4, which prevent backflow or incorrect delivery of liquids.

The pumping device 2 comprises a housing 4 containing a conveying chamber 16 with conveying elements 5 located therein. The conveying elements 5 divide the conveying chamber 16 into an inlet-side feed chamber 17 and an outlet-side mixing chamber 9.

The beverage preparation device 100 can be operated in four different operating modes, namely a first mode for dispensing cold, liquid milk, a second mode for dispensing tempered, liquid milk, a third mode for dispensing cold milk foam and a fourth mode for dispensing hot milk foam, wherein the milk or the milk foam is dispensed in each case via the dispensing device 101 into a beverage container, for example into a cup placed under an outlet of the dispensing device 101. In addition, the beverage preparation device 100 has a cleaning mode. The beverage preparation device 100 is controlled by an electrical control unit 104 to set the operating modes and the cleaning mode as follows.

### First Operating Mode (Cold Milk)

In the first mode, cooled milk is sucked from the milk container 105 via the pumping device 2, designed here as an external gear pump, via a first access opening O1 in the housing 4 into the feed chamber 17 of the pumping device 2, conveyed via conveying elements 5 into the mixing chamber 9 and pumped via an outlet-side outlet opening O3 through a throttle element DS into the milk dispensing line M2, so that cold milk flows out of the dispensing device 101 when the pumping device 2 is activated. The flow heater 102′ is switched off in this mode. The milk dispensing line M2 could additionally also have a bypass line (by-pass) through which the milk is passed in the first mode of operation to avoid passing the milk through the flow heater 102′ and thereby heating the milk by residual heat from the flow heater 102′. The control 104 activates only the pumping device 2 in this mode.

### Second Mode (Warm Milk)

In the second mode, warm milk is to be dispensed via the dispensing device 101. The second mode of operation differs from the first mode of operation in that the control 104 activates the flow heater 102′ just before the pumping device is activated or simultaneously with the activation of the pumping device, so that milk is heated while flowing through the flow heater 102′. The heating power of the flow heater as well as the delivery power of the pumping device 2 to influence the flow rate of the milk can be adjusted in this operating mode by the control unit 104 depending on the desired target temperature of the milk.

### Third Mode (Cold Milk Foam)

In the third operating mode, cold, coarse-pored milk foam is to be dispensed at the dispensing device 101, floating on a beverage surface. The flow heater 102′ is switched off as in the first operating mode or is bypassed by a by-pass line. The control unit 104 simultaneously activates the pumping device 2 and the compressor 10 to produce the cold foam. The compressor 10 provides pressurised air at a pressure of, for example, 6 bar. The pressurised air is then blown into the mixing chamber 9 via the second access opening O2 on the outlet side A (high pressure side) of the pumping device 2, and foams the milk in the mixing chamber 9. The second access opening O2 corresponds to a gas inlet for introducing the pressurised gas from the pressurised gas line DL. In this case, the delivery rate of the pumping device 2 is selected to be so high that the milk is accumulated on the outlet side A in front of the throttle element DS located downstream of the outlet opening O3 under a pressure of e.g. 4 bar. The foamed milk is then homogenised as it passes through the throttle element DS.

Fine adjustment of the amount of pressurised air provided is achieved via a valve V located in the pressurised air line DL (between the compressor 10 and the access opening O2). In one possible embodiment, the valve V is a proportional valve V of a pressure regulating device 103, which is controlled electromagnetically via the control unit 104. Instead of the proportional valve, a stutter valve can also be used, which is controlled in a rapidly iterating manner in the manner of a pulse width modulation, i.e. a rapidly clocked opening and closing the valve. By opening and closing the valve in a rapidly alternating manner, the amount of pressurised air and the pressure can be controlled very finely. In addition, the milk in the mixing chamber is subjected to pulsating pressure, which is advantageous for milk foam formation.

Further control of the amount of pressurised gas introduced into the milk can be carried out by regulating the pumping power of the pumping device 2, for example in such a way that the pumping power of the pumping device 2 is set higher to produce fine-pored milk foam with a high density than when producing coarse-pored milk foam with a low density.

### Fourth Mode (Warm Milk Foam)

In the fourth operating mode, hot, fine-pored milk foam is to be dispensed at the dispensing device 101, which mixes with a crema of a beverage located under the outlet of the dispensing device 101, for example an espresso. For this purpose, the control unit 104 activates the pumping device 2 and the compressor 10 analogously to the third operating mode and regulates the valve V. Both the delivery rate of the pumping device 2 and the pressure of the pressurised air provided by the compressor 10 are selected lower than in the third operating mode. In addition, a pressure difference between the pressurised air applied to the access opening O2 and the milk flowing into the mixing chamber 9 is kept low, so that the pressurised air is introduced into the mixing chamber 9 under an overpressure of about 10 to 30% of the milk pressure. This makes it possible to achieve a high proportion of air in the milk and to produce a very fine-pored, homogeneous foam.

Furthermore, in the fourth operating mode, the flow heater 102′ is activated and heats the milk foam prior to dispensing via the dispensing device 101.

### Cleaning Mode

The pumping device 2 and the milk dispensing line M2 can be cleaned with water or a cleaning liquid. To do this, the control unit 104 opens a valve in the water line WL and activates the pumping device 2 so that the pumping device 2 can pump water from the water line WL through the mixing chamber and into the milk dispensing line M2.

To clean the second access opening O2 of the pressurised gas, the pumping device 2 is deactivated in a further step of the cleaning mode. A passage of liquid via the inlet side E of the pumping device 2 through the pumping device 2 is thereby blocked by the stationary conveying elements 5. Via the water line WL, water under water line pressure is fed into the mixing chamber 9 through a cross line between the water line WL and the pressurised gas line DL, in which a non-return valve RV4 is located, through the second access opening O2 and then discharged through the dispensing device 101 via the outlet opening O3 and the milk dispensing line M2. This cleans the outlet opening O3 as well as a connection path of the pressurised air line DL that is potentially contaminated by milk residues.

### Other Operating Modes

Further operating modes can be provided. For example, it is also possible to provide hot, coarse-pored milk foam or cold, fine-pored milk foam, as the milk foam is foamed cold and only heated afterwards via the flow heater 102′, if necessary, so that the type of foam (coarse-pored vs. fine-pored) does not depend or does not depend significantly on the desired temperature of the milk foam at the dispensing device 101.

FIG. 2 shows a cross-section through a pumping device 2 according to the invention, as used in the scheme of FIG. 1: The pumping device 2 comprises a housing 4 with a conveying chamber 16 located therein. The conveying chamber is surrounded by a substantially planar Bottom side 6, a Top side spaced parallel thereto (not shown) and a cylindrical side wall 8 extending vertically therebetween. Two conveying means 5 in the form of gearwheels are mounted in the conveying chamber 16 about respective parallel axes of rotation X1, X2 arranged one behind the other in the plane of the picture, the two conveying means 5 (gear wheels) meshing with one another (FIG. 2, pitch circle diameter d or tip diameter d_{K}) and thereby forming an external gear pump. The two conveying means 5 (gear wheels) are driven by a motor not shown here, e.g. an electric motor, whereby different speeds can be set for conveying milk from the inlet side E to the outlet side A. The motor is electronically controlled for this purpose via the control unit. The motor can be controlled electronically via the electronic control unit 104 referred to in FIG. 2.

The conveying means 5 divide the conveying chamber 16 into an inlet side E with a feed chamber 17 and an outlet side A with a mixing chamber 9. The inlet side E has a single access, namely a first access opening O1, which is formed in the side wall 8 at approximately half the height H/2 of the feed chamber 17. The first access opening O1 extends vertically through the side wall 8 as a round bore and thus forms a constriction acting as a nozzle. Around the first access opening O1, a connection socket is arranged integrally with the housing 4, which forms a first circular-cylindrical fluid channel L1 with a central axis C1. A connection piece 11 is inserted fluid-tightly into the connection socket, via which the pump device 2 can be connected to a fluid line designed as a milk supply line M1.

The outlet side A of the pump device 2 has a single outlet in the form of an outlet opening O3, through which fluid located in the mixing chamber 9 can be discharged. The outlet opening O3 is formed as a circular-cylindrical transverse bore in the side wall 8, whereby a third nozzle DS3 with a variable cross-sectional profile is inserted into the transverse bore. The third nozzle DS3 forms a throttle element via which a counterpressure can be built up in the mixing chamber 9 even at low conveying speeds or conveying volumes. Analogous to the first access opening O1, a third connection socket is formed on the outside of the housing 4 around the outlet opening O3 integral with the housing 4, which forms a third fluid channel L3 with a central axis C3. A connection piece 13 is inserted in the third connection socket for the fluidic connection of the mixing chamber 9 with the milk dispensing line M2 shown in FIG. 1.

As can be seen in FIG. 2, the axis C1 and the axis C3 or the access openings O1 and O3 are arranged at the same height in the side wall 8. A different, especially asymmetrical arrangement is possible.

The mixing chamber 9 has a second access opening O2 in the bottom side 6, which in this case runs vertically through the Bottom side 6. However, the second access opening O2 could also be arranged in the Bottom side 6 at an oblique angle, preferably at an acute angle, and preferably against a flow direction, i.e. aligned with the conveying elements 5. Such a design can induce greater turbulence effects (turbulent flow), which in the case of pressurised gas introduced via the second inlet opening O2 leads to improved mixing of the pressurised gas with the milk in the mixing chamber 16 or in the case of introduced water to improved cleaning of the mixing chamber 16. In order to reduce the pressure required to introduce the pressurised gas, the second access opening can also be aligned in the direction of flow instead of against or perpendicular to the direction of flow.

The second inlet opening O2 (as well as the first outlet opening O3) has a throttle element DS2 inserted into the inlet opening O2. The throttle element DS2 can be used to control an injection pressure and an injection speed of pressurised air and/or water.

The second inlet opening O2 merges into a second fluid channel L2 formed by a connection socket, in which a non-return valve RSV2 and a connection piece 12 are inserted for connection to a pressurised air line DL shown in FIG. 1. The second fluid channel L2 has a branch with an opening O4 which extends into a fourth fluid channel L4. A non-return valve RSV4 and a connection piece 14 are inserted in the fourth fluid channel L4 for fluidic connection to the water line WL shown in FIG. 1. The check valves RSV2 and RSV4 prevent a backflow of fluids in the mixing chamber into the pressurised air line DL and into the water line WL respectively.

The connection piece 12 of the pressurised air line DL, the second fluid channel L2 and the second access opening O2 are arranged coaxially to each other. This minimises flow resistance. The connection piece 14 of the water line WL and the additional opening O4 are arranged perpendicular to the second fluid channel L2.

The opening cross-sections and opening profiles of the access openings O1, O2, O3 and the further opening O4 can be changed depending on the requirement profile by exchanging the bushings used in them. It is possible, for example, to design the openings as standard holes in which different bushings with different opening diameters can be inserted depending on the requirement profile.

FIGS. 3A and 3B show a variation of the milk frothing device 1 from FIG. 2 in perspective views. The geometric design of the delivery chamber 16 of the pumping device 2 as a superposition of two circular cylinders with axes corresponding to the rotational axes X1 and X2 is clearly visible here. The gear wheels of the gear pump and the associated shafts are not shown for reasons of clarity. The drive in the form of a motor, which is also not shown, is mounted on the top side 7 of the housing 4 of the pump device 2 and drives a shaft of a gear wheel via a reduction gear (not shown). The second gear wheel is driven indirectly via the first gear wheel which meshes with it. A tandem drive would also be possible. The bushing 15 represents a mounting opening for the check valve RSV2 shown in FIG. 2.

The pump device 2 of FIGS. 3A and 3B differs from the pump device shown in FIG. 2 in the positioning of the outlet opening O3. The outlet opening O3 is not arranged at half height, but approximately at the height of the first third H/3 of the height of the delivery chamber 16. It is thus offset parallel to the first inlet opening O1, which is arranged at half height (cf. H/2 in FIG. 2).

As can be seen in FIG. 3A, the second access opening O2 is located on the Bottom side 6 of the housing 4 in the immediate vicinity of the side wall 8 and directly in front of the outlet opening O3. Milk conveyed by the pumping device 2 can thus be subjected to a pressurised gas flow immediately upon entering the outlet opening O3.

With regard to all other features of the pump device 2 according to FIGS. 3A and 3B, reference is made to the explanations on the embodiment example of FIG. 2.

FIG. 4 shows a variant of the milk frothing device 1 in the beverage preparation device 100 shown in FIG. 1: The essential difference here lies in the pressure regulating device 103 arranged downstream of the compressor 10 for controlling the quantity of pressurised gas introduced into the pumping device 2. Instead of a proportional valve V used in the embodiment example of FIG. 1, a shut-off valve V′, which can be switched open or closed, and a discharge valve V″, which is arranged downstream in the direction of flow and in a branch of the pressurised gas line DI, are located in the pressurised gas line DL. The shut-off valve V′ and the discharge valve V″ form a pressure regulating device 103. Via the discharge valve V″, the pressurised gas provided by the compressor 10 can be partially discharged into the atmosphere. Compared to the use of a proportional valve located directly in the pressurised gas line or a stutter valve, as in the embodiment example of FIG. 1, pressurised air can be provided over a wider pressure bandwidth. This makes it possible, for example, to set a desired mixing ratio of air to milk via the discharge valve V″ alone, without also having to regulate or change the pumping capacity of the pumping device 2. Therefore, via such a pressure regulating device 103 with a discharge valve, both very coarse-pored foam with a low density for producing a foam crown on a beverage, and at the same time also a very fine-pored foam (microfoam), which mixes well with a crema of a beverage located under the dispensing device 101, can be produced. The control unit 104 regulates the pumping power of the pumping device in this embodiment example only between an on position and an off position.

In the version shown here, the drain valve V″ is designed as a fast-acting stutter valve. However, the drain valve V″ can also be designed as a proportional valve.

For the further, essentially identical details of the beverage preparation device, referral is made to the explanations of the embodiment example of FIG. 1 above.

The invention described provides, inter alia, a structurally very simple but flexible milk foaming device with high mass flow rates which can be used in beverage preparation devices and processes and which can be used to produce milk foams of different consistency and temperature with a homogeneous composition without impairing the pumping function of the pumping device used in the milk foaming device, and which can be dispensed in a uniform volumetric flow.

List of reference signs

| | |
|---|---|
| 1 | Milk frothing device |
| 2 | Pumping device |
| 3 | Gas inlet |
| 4 | Housing |
| 5 | conveying means |
| 6 | Bottom Side |
| 7 | Top Side |
| 8 | Sidewall |
| 9 | Mixing chamber |
| 10 | Compressor |
| 11 | Connection piece |
| 12 | Connection piece |
| 13 | Connection piece |
| 14 | Connection piece |
| 15 | bushing |
| 16 | Conveying chamber |
| 17 | feed chamber |
| 100 | Beverage preparation device |
| 101 | dispensing device |
| 102 | Heating device |
| 102′ | Continuous flow heater |
| 103 | Pressure regulating device |
| 104 | Control unit |
| 105 | Milk container |
| 106 | Air source |
| 107 | Water supply |
| A | outlet side |
| C1 | axis |
| C2 | axis |
| C3 | axis |
| DL | pressurised gas line |
| d | pitch circle diameter (gear wheel) |
| d_{K} | tip diameter (gear wheel) |
| DS | Throttle valve |
| DS2 | Throttle valve |
| DS3 | Throttle valve |
| E | inlet side |
| H | Height |
| L1 | Fluid channel |
| L2 | Fluid channel |
| L3 | Fluid channel |
| L4 | Fluid channel |
| M1 | Milk supply line |
| M2 | Milk dispensing line |
| O1 | Opening (first access opening) |
| O2 | Opening (second access opening) |
| O3 | Opening (outlet opening) |
| O4 | Opening (water supply line) |
| RSV1 | check valve |
| RSV2 | check valve |
| RSV4 | check valve |
| V, | valve |
| V′ | valve |
| V″ | Valve |
| WL | Water line |
| X1 | axis of rotation |
| X2 | axis of rotation |

1. A milk frothing device comprising a pumping device having an inlet side and an outlet side for delivering milk from the inlet side to the outlet side, wherein the inlet side can be connected to a milk supply line, wherein milk is introduced into the pumping device, and wherein the outlet side is connectable to a milk dispensing line for dispensing foamed milk, characterised in that a gas inlet is arranged on the outlet side of the pumping device for introducing a pressurised gas for foaming the milk.

2. The milk frothing device according to claim 1, characterized in that the pumping device comprises a housing, a conveying means arranged in the housing, at least a first and a second access opening, and at least a first outlet opening, the first access opening being arranged on the inlet side upstream of the conveying means, the first outlet opening being arranged on the outlet side downstream of the conveying means, and the second access opening being the gas inlet which is arranged on the outlet side.

3. The milk frothing device according to claim 2, characterised in that the first outlet opening and/or the second access opening comprises at least one of a nozzle or a throttle valve.

4. The milk frothing device according to claim 1, characterised in that the pumping device is designed as a gear pump with two gear wheels which mesh with one another and are arranged rotatably about two axes of rotation arranged in parallel.

5. The milk frothing device according to claim 4, characterised in that the gas access is arranged in the immediate vicinity of the meshing of the gear wheels on the outlet side.

6. The milk frothing device according to claim 2, characterised in that the housing comprises a bottom side, a top side and at least one side wall, the first access opening and the outlet opening being located in the side wall, and wherein the second access opening is arranged in the top side or the bottom side of the housing.

7. The milk frothing device according to claim 2, characterised in that the access openings and/or the outlet opening merge into a first fluid channel, a second fluid channel, or a third fluid channel located in the housing, wherein the first fluid channel, the second fluid channel, or the third fluid channel are designed for connecting a milk supply line, a milk dispensing line, or a pressurised gas line.

8. The milk frothing device according to claim 7, characterised in that a non-return valve is arranged in at least one of the first fluid channel, the second fluid channel, or the third fluid channel.

9. The milk frothing device according to claim 8, characterised in that the second fluid channel has a further opening with an adjoining channel for forming a branch, wherein water can be introduced into the housing via the adjoining channel.

10. The milk frothing device according to to claim 2, characterised in that the second access opening has an opening diameter of at most 10 mm.

11. The milk frothing device according to claim 2, characterised in that the first access opening has a first opening diameter and the first outlet opening has a third opening diameter, wherein the third opening diameter is smaller than the first opening diameter.

12. The milk frothing device according to claim 1, characterised in that the gas inlet is connectable to a compressor for generating pressurized gas.

13. The milk frothing device according to claim 12, characterised in that the pressurized gas is provided under a supply pressure of at least 4 bar, and wherein the pressurized gas is provided under a supply pressure which is higher than a pressure on the outlet side of the milk frothing device when no pressurized gas is supplied.

14. The milk frothing device according to claim 12, characterised in that the compressor comprises a buffer tank.

15. The milk frothing device according to claim 14, characterized in that the milk frothing device comprises a pressure regulating device, wherein the pressure regulating device comprises at least one of a controllable proportional valve arranged between the compressor and the gas inlet, a shut-off valve interposed between the compressor and the gas inlet, or a discharge valve for discharging compressed gas provided by the compressor arranged in the pressurised gas line, with the compressor being controllable and directly connected to the gas inlet.

16. A beverage preparation device for preparing coffee or coffee-mixed beverages, comprising a milk frothing device according to claim 1.

17. The beverage preparation device according to claim 16, characterised in that the beverage preparation device comprises a dispensing device for dispensing foamed or unfoamed milk in a heated or non-heated state, wherein the outlet side of the milk foaming device is connected to the dispensing device via the milk dispensing line.

18. The beverage preparation device according to claim 17, characterised in that a heating device is arranged in the milk dispensing line.

19. The beverage preparation device according to claim 18, characterised in that the heating device is a continuous flow heater.

20. The beverage preparation device according to claim 18, characterised in that the heating device is a steam injector for feeding hot steam into the milk dispensing line, the steam injector being coupled to a steam source or is comprising a steam source.

21. A method for producing frothed milk, by feeding milk into a housing of a pumping device comprising a moving conveyor means for conveying milk from a low-pressure side of the pumping device to a high-pressure side of the pumping device, and introducing a pressurized gas in the region of a moving conveying means wherein the pressurized gas is introduced into the milk on the high-pressure side of the pumping device.

22. The method according to claim 21, characterized in that the pressurized gas is containing at least one of compressed air, compressed nitrogen, compressed oxygen, compressed carbon dioxide, and mixtures thereof, wherein the pressurized gas is at least substantially free from water, and has a temperature of less than 100° C.

23. The method according to claim 21, characterised in that the pressurized gas is supplied to the milk in a pulsating manner.

24. The method according to claim 23, characterised in that the pulsating manner is affected by means of a stutter valve or by dynamically controlled actuation of a compressor.
